(19) United States
(12) Patent Application Publication
(10) Pub. No.: US 2009/0204532 A1
(43) Pub. Date: Aug. 13, 2009

(54) GRAPHICAL TRADING INTERFACE FOR VISUALIZING STOP ORDER DATA

(75) Inventors: Paul RADLE, Frankfurt (DE); Torsten RAUSCH, Frankfurt (DE); Achim BALASCH, Frankfurt (DE)

Correspondence Address: NIXON PEABODY, LLP, 401 9TH STREET, NW, SUITE 900, WASHINGTON, DC, 20004-2128, US

(73) Assignee: DEUTSCHE BORSE AG, Frankfurt (DE)

(21) Appl. No.: 12/029,143

(22) Filed: Feb. 11, 2008

(51) Int. Cl. G06Q 30/00

(52) U.S. Cl. 705/37

(57) ABSTRACT

A computer-implemented method for visualizing trading data may be used together with a graphical user interface of a computer system. The method performs the displaying of a price range including graduated price levels for a tradable item. Data of a stop order is received and evaluated to determine price levels associated with the stop order. Further, a graphical representation of the stop order is displayed in the price range according to the evaluated data. The method may be stored as computer-executable instructions. The instructions are executable by a processor of a computer system which may include a memory for storing the instructions and a display to be used for the visualization. Moreover, a computer-readable medium may include further computer-executable instructions which may perform creating of new price levels in the price range corresponding to each determined price level and calculating executable order volumes for each price level.

### BACKGROUND OF THE INVENTION

1. Field of the Invention

The present invention generally relates to electronic trading systems for financial products and, in particular, relates to the calculation and visualization of stop order volumes.

2. Related Art

In recent years, trading of financial securities has increased considerably. Due to the emerging demand for new financial instruments, new markets, such as the derivative markets, have shown a tremendous growth. Electronic trading systems have become state of the art for trading financial instruments, such as securities and derivatives. Electronic trading systems allow an easy matching of orders with increased speed over manual trading methods. As a consequence, electronic trading systems have entered into floor trading.

Further, the particular order type of stop orders has to be triggered in a first price determination and then becomes an order which will be considered for execution in a second price determination. However, modern electronic trading systems do still not allow traders to efficiently assess stop orders.

### SUMMARY OF THE INVENTION

A computer implemented technique is provided which may facilitate calculating and visualizing trading data, and especially stop order data, using a graphical user interface of a computer system. Embodiments may allow the calculation of volume values representing certain executable order volumes taking the type of trade of the orders into account.

According to an embodiment, there is provided a computer implemented method of visualizing trading data. The method comprises displaying a price range comprising graduated price levels for a tradable item. The method further comprises receiving data of a stop order for the tradable item and the evaluation of the data to determine price levels associated with the stop order. Moreover, a graphical representation of the stop order in the displayed price range is additionally displayed according to the evaluated price levels.

In another embodiment, a trading data visualization system includes a processor, a memory coupled to the processor and a display. Further, the memory is adapted to provide computer executable instructions which may perform a method of visualizing trading data on the display. The method may be similar to that of the above mentioned embodiment.

In a further embodiment, computer readable media are provided which store computer executable instructions. The computer executable instructions perform, when executed, a method which comprises the receiving of data of a stop order for a tradable item. Further, the method comprises evaluating data to determine price levels associated with the stop order and determining whether the determined price levels are part of a price range. Moreover, if the determined price levels are not part of the price range, a new price level is created in the price range and order volume values representing certain executable order volumes are calculated based on the evaluated data.

### BRIEF DESCRIPTION OF THE DRAWINGS

The accompanying drawings are incorporated into and form a part of the specification of the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 is a block diagram illustrating the display of an order book including particular orders according to an embodiment;

FIGS. 2 to 6 are block diagrams illustrating the display of an order book with varying types of orders according to various embodiments;

FIG. 7A is a block diagram illustrating the display of an order book including a plurality of different orders according to an embodiment;

FIG. 7B illustrates the visualization of stop orders on the selling side of FIG. 7A in more detail according to an embodiment;

FIG. 8 is a flow chart illustrating steps to be performed to refresh the order book display according to an embodiment;

FIG. 9 is a flow chart illustrating steps of calculating/re-calculating order volume values on the buying side of an order book according to an embodiment;

FIG. 10 is a flow chart illustrating steps of calculating/re-calculating order volume values on the selling side of an order book according to an embodiment;

FIG. 11 is a flow chart illustrating steps of calculating/re-calculating the surplus of order volume values in an order book according to an embodiment;

FIG. 12A is a flow chart illustrating steps of determining graphical representations on the buying and selling side of the order book according to an embodiment;

FIG. 12B is a flow chart illustrating steps of determining graphical representations on the buying and selling side of the order book according to another embodiment; and

FIG. 13 is a block diagram depicting an exemplary system in which the present invention may be implemented according to an embodiment.

### DETAILED DESCRIPTION OF THE INVENTION

The illustrative embodiments of the present invention will be described with reference to the figure drawings wherein like elements and structures are indicated by like reference numbers.

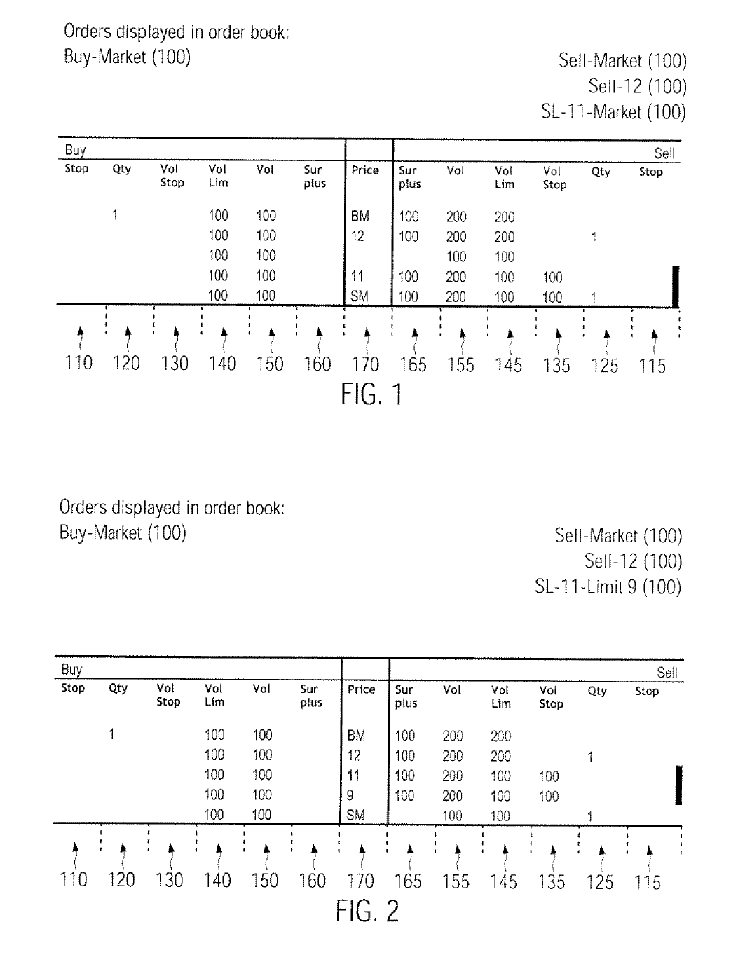

Referring firstly to FIG. 1 which provides an embodiment of the present invention displaying an order book including four orders of different order types. The orders may be placed as a buy order or a sell order. The order book depicted in FIG. 1 shows all buy orders on the left-hand side and all sell orders on the right-hand side. In a further embodiment of the present invention, the buying side and buy orders displayed in the order book are referred to as bid side or bid orders. Similarly, a sell order or the selling side of the order book may be referred to as an ask order or the ask side of the order book.

In general, an order may be of one of at least four different types. These types may be, for example, a market order, limit order, stop limit order or stop market order. A market order, for selling or buying a tradable item, has to be considered for execution for any execution price currently possible.

The second type of order mentioned above, i.e. a limit order, needs to be contemplated separately for a buy order or sell order. In detail, a buy limit order has to be considered for execution when the execution price is equal to or less than the order limit. On the other hand, a sell limit order has to be considered for execution when the execution price is equal to or greater than the order limit. Thus, the order will be executed only at the limit price or at a price more favorable to the investor placing the limit order.

The third type of order mentioned above, i.e. the stop limit order, also needs to be contemplated separately for the buying side and the selling side. In particular, a stop limit order to buy a tradable item will be triggered when the execution price is equal to or greater than the stop limit. Further, when the stop limit order has been triggered, it becomes a limit order which will be considered for execution against the execution price as described above with respect to the limit order. Similarly, a stop limit order for selling a tradable item will be triggered when the execution price is equal to or less than the specified stop limit. After the stop limit order has been triggered, it immediately becomes a limit order. In case of a stop limit order, two prices must therefore be specified, i.e. the stop price and the limit price.

Finally, the fourth type of order is the stop market order which also differentiates between buying or selling a tradable item. For buying a tradable item, the stop market order will be triggered in the same manner as the stop limit order, i.e. when the execution price is equal to or greater than the stop limit. However, when the stop market order is triggered, it immediately becomes a market order and will be handled as mentioned above for the market order. Similarly, a stop market order for selling a tradable item is triggered when the execution price is equal to or less than the stop limit, and then becomes a market order. In other words, a stop market order, sometimes also referred to as a stop order or stop-loss order, is executed at the best available price once a bit or offer is made at that particular price or a less-favorable price.

In conclusion, a market order may be executed immediately, while the execution of any stop order is typically done in a two-stage process. Thus, in a conventional system the first stage is a price determination for triggering the stop limit, while the second stage is the price determination for executing the order.

Referring back to FIG. 1, an order book is displayed including one market order for buying the tradable item displayed in the order book and three orders for selling the tradable item. In particular, the three sell orders are one market order, one limit order, referred to as “Sell-12”, and one stop market order, referred to as “SL-11-Market”.

The order book itself is displayed as a table including six columns for the buying side, six columns for the selling side and one column for a price range including several price levels. It is to be noted that in another embodiment, the depiction of the order book may not be based on columns, but may instead be based on rows, turning the visualizations of the order book from a vertical representation to a horizontal, i.e by 90 degrees. Thus, in this secondary embodiment the table may be displayed having six rows for each side, i.e. the selling side and the buying side, and one row for the price range. In a further embodiment, the number of columns or rows shown in the order book may be more than six or even less than the six depicted columns.

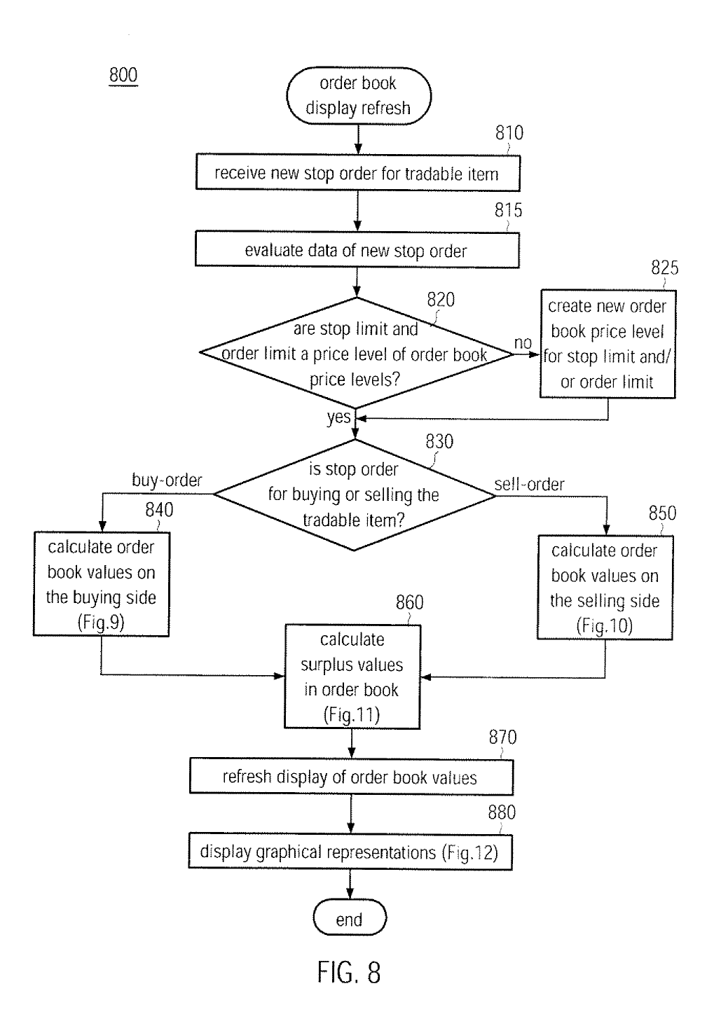

Referring back to the embodiment displayed in FIG. 1, the column 170 displaying the price range includes the price level for market orders on the buying side as well as on the selling side and several price levels in between. The price level for market orders on the buying side has been referred to as “BM”. Similarly, the selling price level has been referred to as “SM”. The price levels displayed in between these two values may be dependent on the orders displayed in the order book. In particular, the price level having the value of “12” is derived from the limit order “Sell-12”. Further, the price level of “11” has been derived from the stop market order “SL-11-Market”. These relations are discussed in more detail below with respect to FIG. 8. Turning back to FIG. 1 one row for a price level in between the limit price levels of 11 and 12 is also depicted. However, in another embodiment, this row in between the limit price levels will not be employed and depicted. In a further embodiment, more than one intermediate price level may even be displayed.

Referring to the buying side of the displayed order book of FIG. 1, there is only one market order to be displayed. The column 120 displays the quantity (Qty) of placed orders not being a stop order. Therefore, column 120 includes only one value in the row corresponding to the price level for the market order on the buying side, i.e. the first row.

Further, column 140 (“VolLim”) depicts the accumulated executable order volume of limit orders and market orders for each price level. Since there is only one market order on the buying side having an order volume of 100, there is displayed the value of 100 for each price level from the price level for market orders to any other favorable price level.

Column 150, referred to as “Vol”, depicts the accumulated executable order volume of limit orders, market orders and stop orders for each price level. In other words, column 150 depicts the summarized values for each price level of columns 140 and 130. Since there is no value in column 130, the values of columns 140 and 150 are equal.

Turning now to the selling side of the displayed order book of FIG. 1, corresponding columns are displayed which depict the same values as on the buying side in a bilateral manner. To make this apparent, the reference numerals for each column on the selling side are the reference numerals for the corresponding column of the buying side, plus 5.

FIG. 1 depicts on the selling side the order volumes and order quantities for the above mentioned three orders. Referring first to column 125, the quantities of market orders are depicted. The value of 1 in the last row, corresponding to the price level of market orders on the selling side, results from the order referred to as “Sell-Market”. The value of 1 in column 125 on the price level of “12” results from the limit order “Sell-12”. It is to be noted that as mentioned above, a sell limit order has to be considered for execution when the execution price is equal to or greater than the order limit. Thus, all corresponding values of this limit order will be displayed in the row corresponding to the price level of “12” and higher.

Referring first to column 145, the accumulated executable order volumes of limit orders and market orders are depicted for each price level. Thus, the first rows include the summarized order volumes of the market order “Sell-Market” and the limit order “Sell-12”. The remaining three rows, below the price level of 12, depict the order volume of the market order only, since the limit order is only executable for a limit of 12 or higher.

Referring now to column 135 (“VolStop”), the accumulated executable order volumes of stop orders are depicted for each price level. Since the stop market order (“SL-11-market”) will be triggered at the price level of “11” and is then a market order, column 135 depicts the order volume of 100 in the last two rows, i.e. price level “11” and lower.

Since stop orders need to be triggered before they may be considered as a market order or limit order, it is not favorable to display the stop order volumes in column 145 depicting the executable order volumes. Since it might be difficult for the trading person using conventional order books to differentiate between directly executable orders (e.g. market orders) and stop orders, the present invention includes different columns for the accumulated order volumes of executable orders and stop orders, as well as an area to visualize the stop order volumes. These visualization may be found in columns 110 and 115, which provide a graphical representation of the stop orders. With respect to FIG. 1, there is no stop order on the buying side, thus leaving column 110 empty. However, the stop market order on the selling side is displayed as a bar covering the price level of 11 and the price levels below, which are the specified stop limit and the levels of a possible execution. In the present case, there is only one further price level, i.e. “SM”, below the limit price of 11. Thus, the present invention provides not only the executable and accumulated order volumes for stop orders and all remaining orders, but also provides a visualization for each price level of whether stop orders are executable. A trading person using the inventive order book visualization is therefore relieved from the burden of handling a plurality of order books and going through a vast amount of numbers, i.e. summarized order volumes. The trading person can now easily see at which price levels stop orders may become executable orders.

Finally, referring to columns 160 and 165, a surplus is calculated between the summarized order volumes of the buying side and selling side. In other words, columns 160 and 165 depict the difference of columns 150 and 155. It is to be noted that in the depicted embodiment, the surplus is only shown on the side of the order book, where the surplus is positive. However, in a further embodiment, the surplus may be displayed on both sides of the order book. Thus, since column 155 depicts for each price level the summarized values of columns 145 and 135, there will be a surplus in the first two and the last two rows of the order book as depicted. In another embodiment of the present invention, a possible surplus may be calculated and displayed which is only based on limit orders.

As mentioned above, the order book may include further columns illustrating various information. For example, an additional column may include accumulated order volumes which may be triggered at the certain price levels. On the other hand, in another embodiment, the order volumes of stop orders may only be listed at the price level corresponding to the stop limit, i.e. the price level which triggers the stop order. Further, on a certain price level the order volumes of executable stop orders may be displayed, as well as the order volumes of limit orders. In an embodiment of the present invention, the order volumes of stop limit orders may be displayed where these orders end, i.e. on the price limit specified by the stop limit order. Moreover, instead or in addition to the order volumes, the number of orders of the above discussed orders may be shown. For example, the order book may include columns depicting the number of executable stop orders, the number of orders which are triggered on the price level, and the number of stop limit orders that end on a certain level. In yet another embodiment, a visual indication of the order volumes may be displayed representing the order volumes at the specific price levels of stop orders and limit orders combined.

With respect to a further embodiment, the order book may be displayed with two price ranges, one for the buying side and one for the selling side. The different price levels of all orders may be aligned, so that the order book does not include one row with two different price levels on each side or two rows with the same price level. In an exemplary implementation of the above mentioned embodiment, the price ranges may also be sorted in opposite directions. In other words, the price range of the buying side may be independent of that of the selling side. Thus, the price level for market orders on the buying side “BM” may be in the top row of the price range, as well as the price level for market orders on the selling side “SM”. Further, the price levels on the buying side would then be in a descending order, while on the selling side they would be in an ascending order.

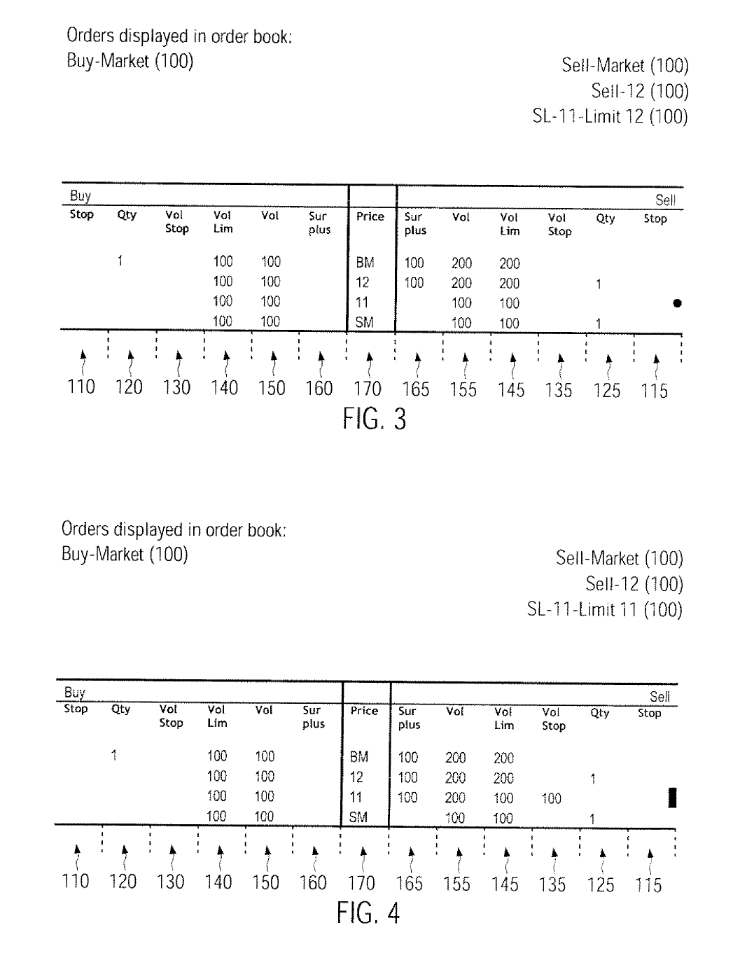

Referring now to FIG. 2, a further example order book is depicted. This displayed order book includes three orders which are equal to the orders of FIG. 1. However, the stop market order of FIG. 1 has been replaced by a stop limit order referred to as “SL-11-Limit 9”. Thus, the values of columns 120, 140, 150, 145 and 125 are equal to the values in the same columns of FIG. 1. Since a further limit value has been introduced with the new order, the order book of FIG. 2 includes one more row than the order book of FIG. 1. In particular, the new order includes an order limit of 9, which results in the depicted row for the price limit of 9. It is to be noted that in a further embodiment of the present invention, one or more intermediate price levels may be displayed in between the price levels of 11 and 9 or in between the price level of 9 and right above “SM”.

While the stop market order depicted in FIG. 1 results in the same order volume value in column 135 for each row from the price level of 11 down to the price level of “SM”, the accumulated stop order volume values depicted in FIG. 2 can only be found on the price levels of 11 and 9. If, in a different embodiment, an intermediate price level is displayed in between the levels of 11 and 9, the stop order volume value would also be displayed on the intermediate level. In accordance with the executable stop order volume values, column 115, referred to as “Stop” on the selling side, includes a visualization of stop orders which may be triggered at a price level of 11 or lower but are limited to the order limit of 9. Thus, the graphical representation of the stop order covers the price levels of 11 and 9. Again, if a further embodiment depicts intermediate price levels in between the price levels of 11 and 9, the graphical representation of the stop order would also cover these intermediate price levels.

Referring now to FIG. 3, an order book is displayed where the same types of orders are represented as shown in FIG. 2. However, the stop limit order now has an order limit of 12. Thus, the order book depicted in FIG. 3 does not include a row for the price level of “9”.

It is to be noted that FIG. 3 represents a certain case of stop limit order. In particular, the order limit is greater than the stop limit. While FIG. 2 depicts a graphical representation going from the price level of the stop limit to the price level of the order limit, FIG. 3 can not include such a graphical representation. In detail, the stop limit order will be triggered if a price of 11 or less has been determined. After triggering, the stop limit order becomes a limit order having the order limit of 12. Thus, this particular stop limit order is not executable within the same price determination. While the order book depicted in FIG. 2 allows the triggering and execution of the stop limit order, this would not be possible for the stop limit order of FIG. 3.

It is further to be noted that the column 135 “VolStop” does not include any order volumes, since the stop limit order is not executable. Thus, having traditional electronic order books a trading person would not immediately be aware of a stop limit order having these particular limits. The present invention, on the other hand, provides a user convenient order book visualization. In detail, this particular stop limit order is visualized by a dot at the price limit of the stop limit, i.e. the price limit of 11. Further, after the stop limit order has been triggered, the dot may not be replaced by a bar, but instead no graphical representation will be depicted, since the stop limit order has become a “normal” limit order. The triggered stop limit order, i.e. converted to a limit order, may then be executable for certain price levels and its order volume may, for example, appear in column 145 showing the accumulated executable order volumes of limit orders and market orders.

Turning now to FIG. 4, a similar order book is shown as represented by FIG. 3. It is to be noted that the stop limit order has now changed by having an order limit of 11, which is equal to the stop limit. Thus, the values and graphical representation depicted in FIG. 4 correspond to those depicted in FIG. 2. However, the values and graphical representation of the stop limit order may only be found in the row of the price level of 11. Thus, the columns 135 (“VolStop”) and 115 (“Stop”) include the value of 100 at the price level of 11 and a graphical representation covering only this price level.

Referring now to FIG. 5, the visualization of an order book is depicted having three orders different from those of FIGS. 1 to 4. In detail, FIG. 5 now illustrates one limit buy order “Buy-12” and two stop market orders “SB-11” and “SL-12”. The latter of the stop market orders is for selling a tradable item. Thus, the selling side only includes order volume values in columns 135 and 155 (also referred to as “VolStop” and “Vol”). These order volume values may be displayed in accordance with this type of order from the price level of “12” down to the lowest price level, i.e. “SM”. Moreover, since the stop market order on the selling side will be triggered, and is hence executable, at the price level of 12, a graphical representation of the stop order can be found in column 115 covering all price levels from price level 12 down to the lowest.

Referring to the buying side of FIG. 5, the values according to the limit order “Buy-12” can be found in column 120 (“Qty”) and column 140 (“VolLim”). In detail, the first column depicts the quantity of one order at the price level of 12 corresponding to the limit price of this order. Since the limit order becomes a market order, the second mentioned column 140 includes order volume values of 100 from the limit level of 12 down to the lowest price level, i.e. “SM”.

Finally, the third depicted order is a stop market order with a stop limit of 11. Thus, the column 130 (referred to as “VolStop”) includes order volume values of this order from the price level of “11” up to the highest price level, i.e. “BM”. This is due to the market order which will be “instantiated” if the stop market order has been triggered at a price level of 11.

Since FIG. 5 now includes a stop order on the buying side as compared to FIGS. 1 to 4, the column 110 includes a graphical representation of the stop market order “SB-11”. This graphical representation covers the stop limit price level of “11” and all price levels above up to the highest price level.

Referring to FIG. 6, an order book is illustrated which includes the same three orders as depicted in FIG. 5 and two additional stop limit orders, in particular, one stop limit order on the selling side, referred to as “SL-11-Limit 11” and one stop limit order on the buying side referred to as “SB-12-Limit 13”. Thus, the values and graphical representations as depicted in FIG. 5 can also be found in FIG. 6.

It is to be noted that the graphical representation of the stop market order “SB-11” on the buying side now covers the additional price level of 13. This reflects that the graphical representation covers the price limits from the limit price level up to the highest depicted price level.

In addition, the stop limit orders are also represented by a graphical indication. On the buying side, the stop limit order covers the price levels of 12 and 13, which are the stop limit and the order limit. On the selling side, the stop limit order has two equal limits, i.e. stop limit and order limit are both 11, which results in a graphical representation only covering the price level of 11. Moreover, the values and graphical representation of this particular stop limit order “SL-11-Limit 11” can also be found in FIG. 4.

As can be seen in FIG. 6, the surplus depicted in columns 160 and 165 results in a positive surplus in only three price levels on the buying side. Further, it is to be noted that the amount of illustrated price levels depends on the limits which can be evaluated from all depicted orders. However, in a further embodiment, an equal amount of price levels may always be depicted between the price levels for the bid and ask market price independent of the amount of orders or the limits of these orders. For example, in such an embodiment, one price level for each integer price may be depicted, or one price level for each level corresponding to 0.5, etc. Thus, according to different embodiments of the present invention, the level shown between the price levels of 11 and 12 may represent the price level of 11.5, there may be another intermediate level or the price level may not be depicted at all.

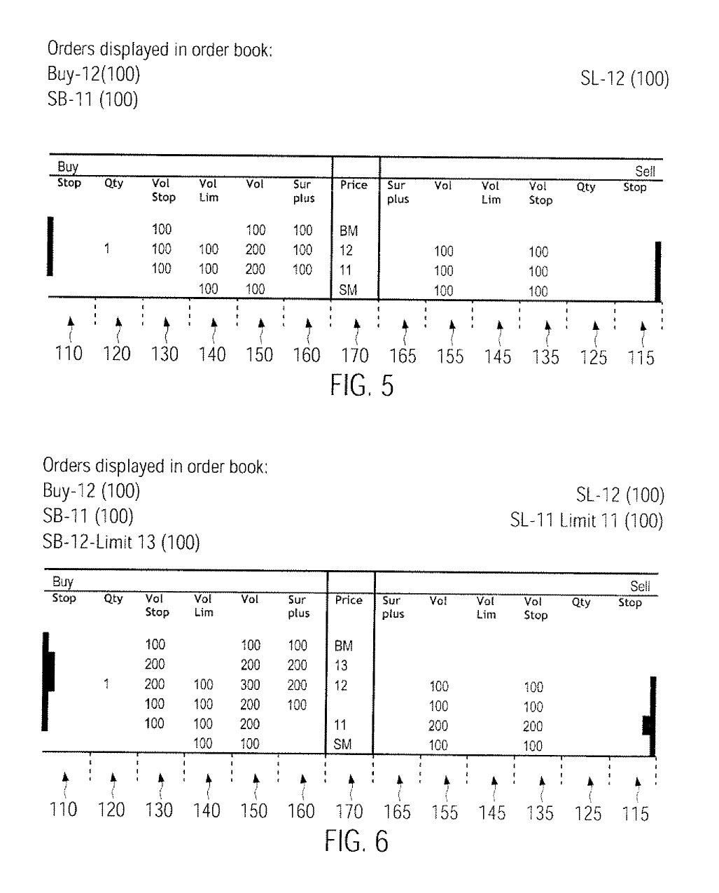

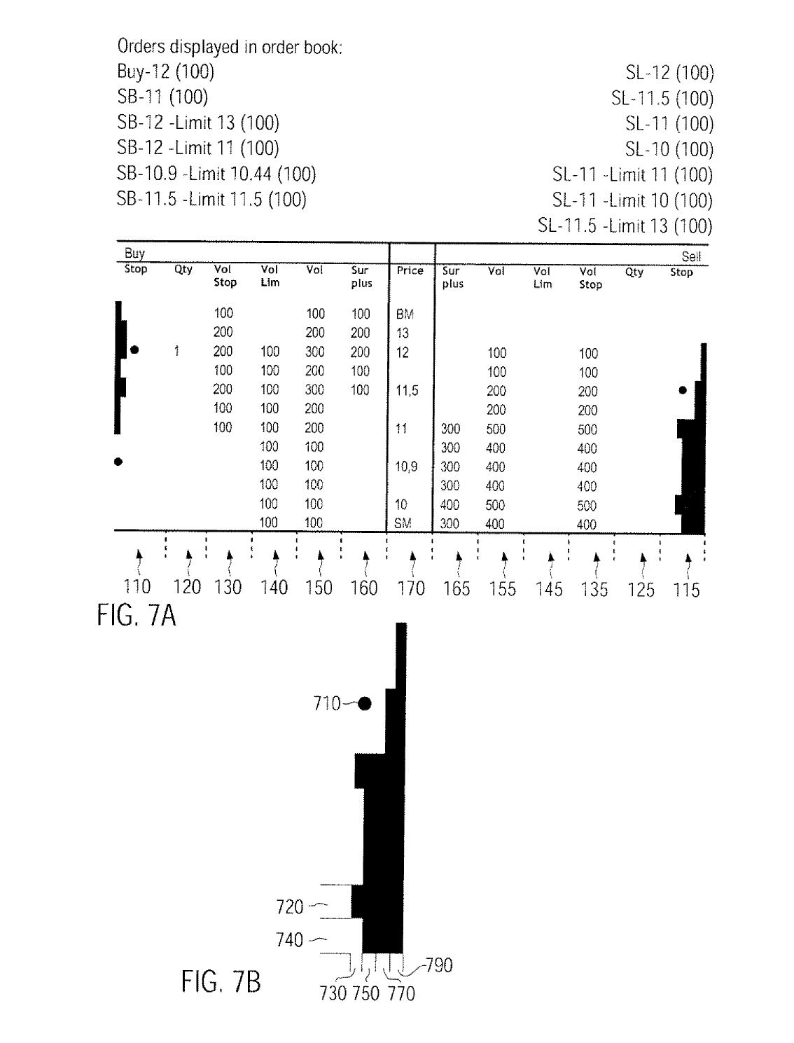

With respect to the embodiment depicted in FIG. 7A, an order book representation is shown which depicts 13 different orders. As can be seen, five of these orders are already depicted in FIG. 6, while eight additional orders may be found in FIG. 7A. Further, three additional orders are on the buying side, while five additional orders can be found on the selling side.

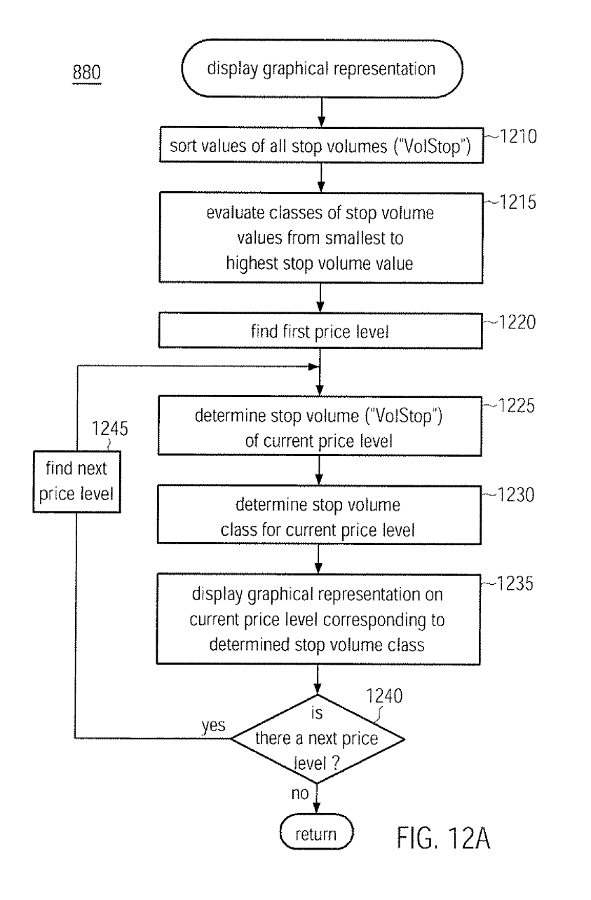

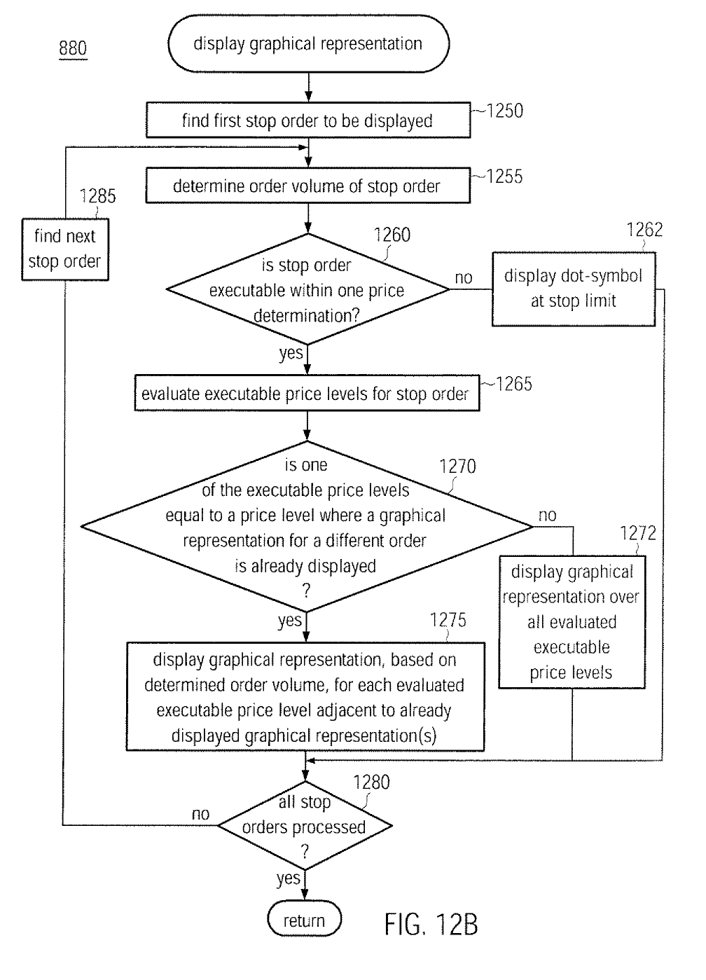

While FIGS. 1 to 5 only illustrate order books having a maximum of one stop order on each side, FIG. 7A illustrates an order book displaying multiple stop orders on both sides. For example, the buying side illustrated in FIG. 7A includes five stop orders, where three of them are represented by a bar, and two stop orders are depicted as a dot. However, in another embodiment, the orders are not each represented by bars, but the accumulated stop order volume is represented by a bar on each price level. These different embodiments will become more apparent with the description of the methods illustrated in FIGS. 12A and 12B. Referring back to FIG. 7A, the latter two stop orders are both not executable due to the limits set. As outlined above with respect to the selling side of FIG. 3, these two orders on the buying side of FIG. 7A have a stop limit which is greater than the order limit. These two non-executable orders are referred to as “SB-12-Limit 11” and “SB-10.9-Limit 10.44”. Thus, each dot is displayed at the price level of the stop limit, i.e. 12 and 10.9 respectively, to visualize that stop orders will be triggered at these limits, which however will not be executable with the same price determination. In a different embodiment, the graphical representation for the stop order referred to as “SB-12-Limit 11” may not be displayed, since this price level includes a representation for a stop order already. In particular, as depicted in FIG. 7A, the price level of 12 indicates in column 110 that stop orders having an accumulated order volume of 200 are already present. Thus, a trading person may not need the additional information of a dot.

Referring now to FIG. 7B which illustrates the visualization of stop orders on the selling side of FIG. 7A. In detail, the dot 710 indicates that a stop limit order has been placed which is not executable with the same price determination as of the triggering. As can be seen in FIG. 7A, this stop limit order has a stop limit of 11.5 and relates to the order “SL-11.5-Limit 13”. Again, similar to the stop limit order described above with respect to FIG. 3, the order limit is greater than the stop limit. In particular, if a price level of 11.5 is hit, this will trigger the order but it will become a limit order with a price limit above the current (triggering) price level. In addition, as described above, the dot 710 may, in a further embodiment, not be displayed, since other stop orders are already available on the price level of 11.5.

Referring back to FIG. 7B, the bars 750, 770 and 790 visualize the orders “SL-11”, “SL-11.5” and “SL-12”. Since all three mentioned orders are stop market orders, the visualization starts at the limit specified by the respective order. Further, the orders will become a market order when triggered. Thus, all visualizations, in the depicted embodiment solid bars, cover all price levels from the limit to the lowest price level, i.e. “SM”. As mentioned above, in a different embodiment of the present invention the visualizations may be bars on each price level reflecting the accumulated stop order volume (see FIGS. 12A and 12B).

In any case, with respect to the visualization 730, the accumulation of stop orders can be seen. In particular, the bar 730 includes a visualization of the stop limit order “SL-11-Limit 10” and half of the stop market order “SL-10”. The just-mentioned stop limit order alone would only be represented by a bar covering the price levels from 11 to 10. A comparable visualization has been described above with respect to FIG. 2. The second and intervening visualization depicts a stop market order which starts at the limit of 10 and covers all price levels from 10 down to the lowest price level. Thus, the visualization of the order “SL-10” is actually the extending bar at 720 and the part of bar 730 intersecting with the row numbered as 740.

In the other embodiment having bars reflecting the accumulated stop order volume, the graphical representation at 720 depicts an accumulated stop order volume which is greater than that represented at 740.

It is to be noted that all orders used for the illustration of FIGS. 7A and 7B have an order volume of 100. However, during an actual implementation of the present invention, this would be quite unlikely. Thus, the bars 720, 730 and 750 to 790 depicted in detail in FIG. 7B may be of different width corresponding to the order volume of the illustrated stop orders. In case of the above described order “SL-10”, its graphical representation may further vary, dependent on the already existing and depicted stop orders. In a further embodiment, the width of the bars 720, 730 and 750 to 790 may correspond to a certain class of order volume, e.g. 100, 200, 300, etc. In this embodiment, the stop orders may only be depicted, if their volume falls into one of these classes. Thus, the order volumes may be classified for the graphical representation. Moreover, with respect to the graphical representation for stop orders that are not executable in one price determination, in another embodiment of the representation may also have varying sizes dependent on the order volume it represents. For example, the diameter of the dot may have a certain size for an order volume of 100 and may have a greater diameter for an order volume of 500 and more. Thus, the diameter may either correspond to certain classes of order volume sizes or may be directly calculated from the order volume it illustrates.

These embodiments of the present invention might allow an easier process for generating and displaying of the visualizations or a more user convenient way to interpret the visualizations, although the graphical representation may not reflect the exact order volumes. In addition, in an embodiment of the present invention a user preference setting may be provided, where a user of the order book may choose between the different visualization modes described above. For instance, the user may specify the size of each order volume class or how many classes of order volumes shall be depicted. The latter may further be based on the smallest and the highest accumulated order volumes, i.e. the smallest and highest values of, for example, column 130 (or 135).

As can further be seen from the above description of FIG. 7B, the present invention provides a very user convenient way of visualizing stop orders in an order book. A trading person using the order book of the present invention can spot very quickly that there is a total volume of at least 400 for each price level below 11 and down to the price level “SM” which can be executed the moment the price level reaches 11 or less. It doesn't matter whether there are four or five orders involved. The visualization of the stop orders provides a very user convenient way to represent the accumulated executable order volume.

It is to be noted that in another embodiment, the visualizations in columns 110 and 115 may include different colors for different stop orders or different shades of gray. This would even allow the provision of the information that the bars 730 and 750 to 790 are composed of a total of five stop orders. Thus, the present invention may provide a user preference setting, where a user of the order book of the present invention may choose between a solid color for all stop orders, or different colors or shades of gray for each stop order visualized.

As can be seen from FIGS. 1 to 7A, the order book of the present invention includes one price level for each limit of all depicted orders. With respect to FIG. 8, a process is shown which may be used to refresh the display of the order book. For example, the process may start when a new stop order for a tradable item is received (step 810). However, in another embodiment, the process may start at certain time intervals such as every five seconds. In a further embodiment, the process may be started with the reception of any kind of order.

Referring back to FIG. 8, after a new stop order has been received, it is determined whether the stop limit of the stop order corresponds to a price level depicted in the order book.

The price limit of the stop limit may be determined by evaluating, at step 815, data received with the stop order. For example, a stop order may include data such as the type of trade, the stop limit value, an order limit value and/or the order quantity. The trading type may indicate whether the order is for buying or selling the tradable item. For example, a generally accepted identifier for a buying order, selling order, market order, limit order, stop limit order or stop market order may be employed. Thus, a standard could be established so that the method and system of the present invention could be employed with any order system, as long as the order system fulfils the standard.

Referring back to FIG. 8, if at step 820 it is determined that the price level of the stop level is not part of the price range depicted in the order book, a new price level is created for the stop limit (step 825). Thus, a price level for each stop limit will be part of the price range depicted in the order book. In addition, simultaneously it is determined whether the stop order includes an order limit (in case of a stop limit order) and whether this order limit is a price level of the order book already. If not, a corresponding price level will be generated at step 825. In another embodiment, the evaluation of an order limit and the creation of a corresponding price level may take place in separate steps of the method of FIG. 8. However, the process then makes a further determination at step 830 as to whether the stop order is for buying or selling the tradable item. As outlined above, the trading type of the order may also be determined by evaluating the data received with the stop order.

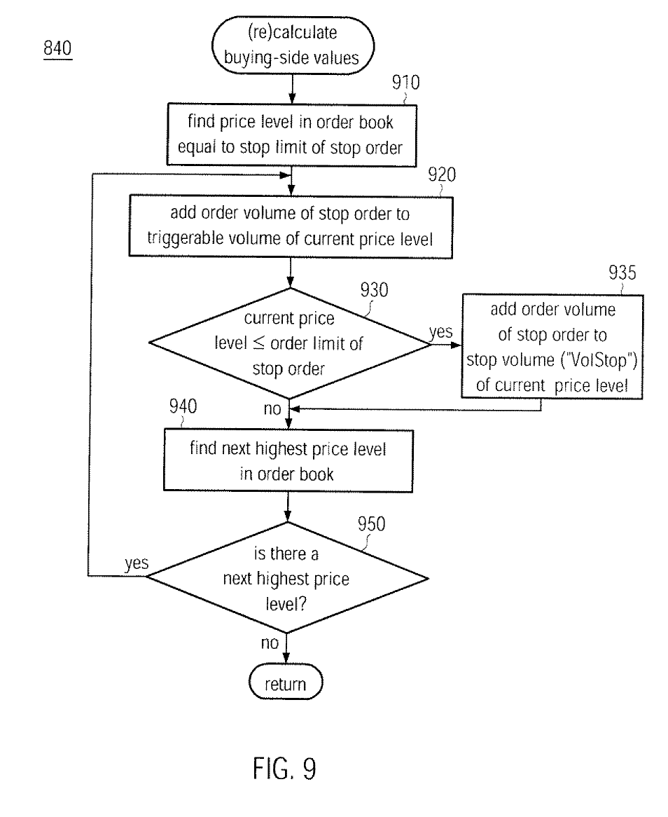

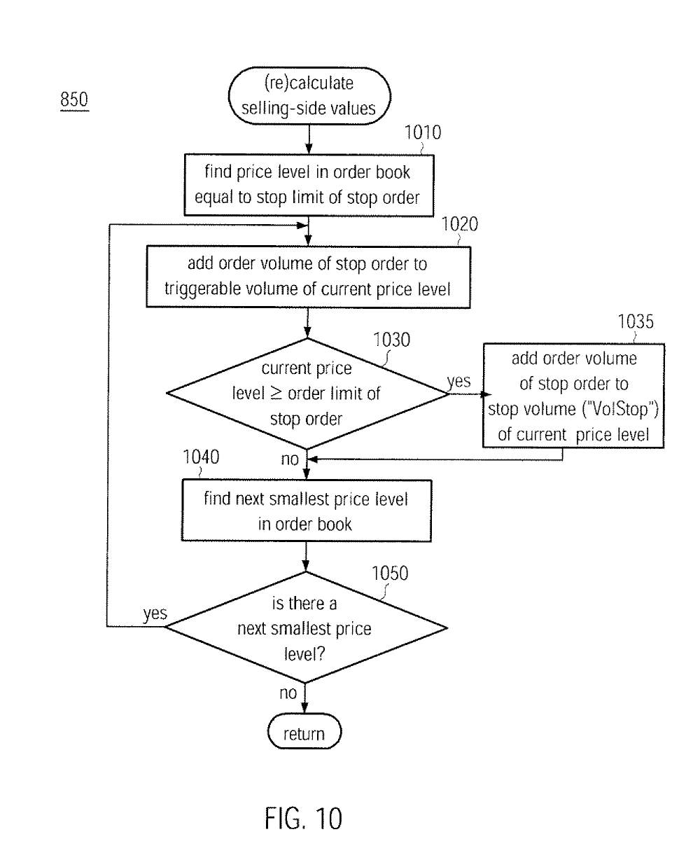

Depending on the order type, the order book values on the buying side of the order book (step 840) or on the selling side of the order book (step 850) are calculated. These calculations are illustrated in more detail in FIGS. 9 and 10, respectively. It is to be noted that in another embodiment of the present invention, the order book values on both sides may be recalculated regardless of whether the new order is for buying or selling. Thus, while requiring more processing effort, the depiction of wrong or obsolete values on one side of the order book is avoided.

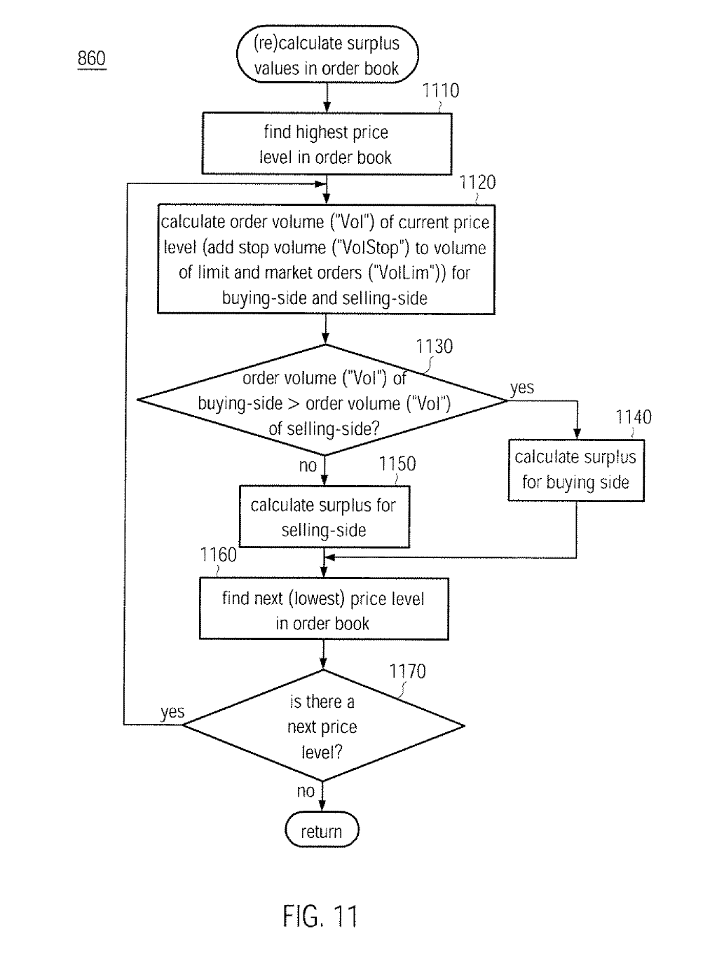

After the calculation of the order book values, the surplus values in the order book are calculated or recalculated at step 860. This calculation of the surplus is described in more detail further below with respect to FIG. 11.

The depiction of the order book is then refreshed (step 870), i.e. the new calculated order volume values are displayed. In another embodiment, a step of determining whether price levels of executed orders may be removed from the order book is performed before the display is refreshed. This determination and the removal of obsolete price levels may also be performed at the beginning of the overall process, for example, before the step 820. In a further implementation the determination and removal may be performed in a separate process, for example, each time when an order has been executed.

The display refresh (step 870) may include a renewal of the visualizations, such as the visualization depicted in FIG. 7B. However, in an embodiment of the present invention, the displaying of the graphical representations or visualizations is performed in a separate step 880. The creation or renewal of the graphical representations is described in more detail further below with respect to FIGS. 12A and 12B.

For example, when starting from the order book display of FIGS. 7A and 7B, a new order may, for example, be a stop limit order on the selling side having a stop limit of 10.99, an order limit of 10.01 and an order volume of 100. Thus, two new limits would be added to the order book right below the price level of 11 and right above the price level of 10, as outlined above in steps 820 and 825. Further, the visualization of the stop orders as depicted in FIG. 7B would then include a new bar which would be right above the visualization part numbered as 720. This new bar would further close the “gap” between the price levels of 10 and 11. The new visualization would then include a solid rectangular block in the middle having a width corresponding to an order volume of 500. Referring to the embodiment described in FIG. 12A, the accumulated stop order volume for all price levels from 11 to 10 would fall into the order volume class of 500.

Referring now to FIG. 9, where the step 840 is described in more detail, the process starts with step 910 where a price level is searched in the order book which is equal to the stop limit of the stop order. Such a price level must exist, since one would be created at step 825 of FIG. 8. Further, the order volume of the stop order is then added to the triggerable volume of the current price level at step 920. The current price level is the price level of the stop order as determined in step 910. In addition, the order volume may also be determined by evaluating the data of the received stop order (step 815 in FIG. 8). As mentioned above with respect to FIG. 1, the accumulated triggerable volume may be displayed in an additional column, but is not depicted in FIGS. 1 to 7A.

Referring back to FIG. 9, at step 930, it is determined whether the current price level is less than or equal to the order limit of the stop order. If the determination is positive, the order volume of the stop order is added to the stop volume of the current price level at step 935. Referring to FIG. 1, this would result in the displaying of the order volume in column 130 (“VolStop”) at the current price level.

It is to be noted that after each calculation of new accumulated order volume values, for instance the calculations of steps 920 and 935, these values may be stored in the electronic order book. In another embodiment, the calculated values may only be stored after the whole process of an order book refresh has been completed. In this case a temporary storage of the new values may be necessary.

After the steps 930 and 935, the method processes to step 940, where the next highest price level in the order book is searched. If there is a next highest price level, the method loops back to step 920 and performs the steps of 920 to 950 until no higher price level can be found. With respect to FIG. 1, the highest price level would be the price level referred to as “BM”. The process then ends and returns back to FIG. 8.

A similar process as described with respect to FIG. 9 will be performed at step 850 of FIG. 8, which is now described in more detail and with reference to FIG. 10. The method described in FIG. 10 illustrates the steps performed to calculate or recalculate the order book values on the selling side. As outlined above with respect to FIG. 9, a price level in the order book equal to the stop limit of the stop order is searched at step 1010 and the order volume of the stop order is added to the accumulated triggerable volume of the current price level at step 1020.

With reference to FIG. 7, the stop order processed by the method of FIG. 10 may be the stop limit order referred to as “SL-11-Limit 10”, which has also been described above with respect to FIGS. 7A and 7B. In this case, the current price level would be 11. The process then determines at step 1030 whether the current price level is greater than or equal to the order limit of the stop order. The order limit in this case is 10 and hence smaller than the current price level of 11. Thus, the method branches to step 1035 where the order volume is added to the stop volume value of the current price level. This means that the order volume of the stop order is added in column 135, referred to as “VolStop”.

It is to be noted that after each calculation of new accumulated order volume values, for instance the calculations of steps 1020 and 1035, these values may be stored in the electronic order book. In another embodiment, the calculated values may only be stored after the whole process of an order book refresh has been completed. In this case a temporary storage for the new values may be necessary.

The method then searches for the next smallest price level in the order book at step 1040 and determines at 1050 whether there is a next smallest price level. Thus, the steps of 1020 to 1050 will be repeated until the current price level is lower or smaller than the order limit of the stop order. In the above mentioned case, this would mean that the current price level would reach the price level referred to as “SM” which is the next lowest price level below 10. Thus, at the price level “SM”, the current price level is lower than the order limit (step 1030) and the order volume of the stop order is not added to the value of column 135. The method of FIG. 10 then ends by returning to step 860 of FIG. 8.

With reference now to FIG. 11, the calculation or recalculation of the surplus values in the order book is described. First, the highest price level in the order book is searched at step 1110. The process then calculates the order volume of the current price level for the buying side and the selling side. The calculated order volumes can then be found in columns 150 and 155 (“Vol”) of FIGS. 1 to 7A. The step 1120 includes the addition, for the current price level, of the stop volume value to the volume of limit and market orders. In other words, step 1120 includes the addition of the value of column 130 to the value of column 140 for each price level and putting the result into column 150. On the selling side, the same addition occurs, i.e. summarizing the values of columns 135 and 145, and putting the result into column 155 for each price level.

The method of FIG. 11 then follows to step 1130 where it is determined whether the order volume of the buying side is greater than the order volume of the selling side. In other words, the values of columns 160 and 165 (of FIGS. 1 to 7A) are compared for the current price level. Depending on which order volume value is greater, the surplus is calculated for the buying side or the selling side, so that a positive result will be calculated. This is depicted in steps 1140 and 1150 depending on the determination made at step 1130. The calculation of the surplus may be a subtraction of the value of columns 150 and 155 for the current price level. A further embodiment of the present invention includes the calculation of the absolute value of the subtraction of the value of columns 150 and 155. This calculated absolute value may then be displayed in addition to or instead of columns 160 and 165, for example in only one column in the middle of the order book. In this case, each value in this column may further be depicted with a shaded or colored background to indicate whether the buying side or the selling side is having a greater order volume.

Further, at step 1160, the next lowest price level in the order book is searched. If there is a next price level determined at step 1170, the method loops back and repeats the steps 1120 to 1170. If no lower price level can be found in the order book, the process ends and may return to FIG. 8.

Referring now to FIG. 12A and FIG. 12B, the generation of graphical representations of the stop orders is described in more detail. It is to be noted that the generation of the graphical representations of the stop orders may be performed by one of a plurality of processes. The skilled person will appreciate that different implementations may be employed to achieve similar or the same graphical representations. Thus, FIGS. 12A and 12B depict only two exemplary processes which may be used alternatively.

It is further to be noted that the steps of each displaying process, i.e. the steps depicted in FIG. 12A or FIG. 12B, will be performed for the buying side of the order book as well as for the selling side. A person skilled in the art will be aware of implementation possibilities to repeat the method for each side or to implement the process in a manner that both sides are evaluate and both visualizations are generated at once.

As illustrated in FIG. 12A, the accumulated executable order volumes of stop orders shown in column 130 or 135 of FIGS. 1-7A may be sorted (step 1210), for example in ascending order. The skilled person will appreciate that the following process may also be performed if the order volumes are sorted in descending order. After sorting the order volumes, the smallest and highest value may be determined.

Further, at step 1215, the process continues with evaluating classes of the sorted stop volume values or accumulated executable order volumes. This evaluation may be based on the smallest and highest volume value and a predefined number of classes. In an embodiment of the invention, the user of the electronic order book of the present invention may specify preferences, including the number of order volume classes. For example, with respect to FIG. 7A, selling side, the smallest value is 100 and the highest is 500. Assuming that the number of order volume classes is five, the process illustrated in more detail below operates with the classes of 100, 200, 300, 400 and 500 ordered items.

Referring back to FIG. 12A, a first price level of the order book may be determined and found at step 1220. For instance, the first price level may be the level referred to as “BM”, i.e. the top-most price level. As will be clear to the person skilled in the art, the first price level may also be level “SM”. In this case, the method of FIG. 12A would process through the price levels in ascending order, i.e. from the lowest to the highest. In each case, at step 1225 the stop order volume (value of column 130 or 135) for the current price level is determined. If the order volume is zero, the process may move directly (not shown) to step 1245 finding the next price level.

As shown in FIG. 12A, the method processes to step 1230 where a stop volume class for the current price level is determined. For example, the stop order volume of the price level “12” is 100 items. Thus, the class for this price level out of the five classes evaluated at step 1215 above is 100. In a different embodiment, where the steps 1225 to 1235 may also be performed for price levels with no stop order volume, the determination of step 1230 may output a null-class which is always available, in case no stop order volume exists.

After determining the class, a graphical representation corresponding to the determined class may be displayed on the current price level in the order book (step 1235). For instance, the first class (corresponding to 100) may be a bar having a particular width. In other embodiments different graphical representations may be employed instead. However, in the embodiment depicted, for example, in FIG. 7A the graphical representation for each class is a bar having a width reflecting the “size” of the class, i.e. the amount of items represented by this class. With respect to the embodiment discussed above, there may even be a graphical representation for the null-class. For instance, this class may be represented by a light shaded bar of a certain size, such as the biggest width of all predefined bars. In a different embodiment, no graphical representation may be defined for the null-class.

Moreover, it may be the case that the current price level includes a stop order which is not executable within one price determination, either alone or in addition to executable stop order volumes. As discussed with respect to FIGS. 3 and 7A a stop order needs to be triggered first. However, the execution of the order may not be possible immediately. Thus, if there is a stop order having a stop limit equal to the current price level and is not executable within one price determination, the above mentioned stop volume class (see step 1230) may be represented by a dot-symbol. This symbol may be displayed in column 110 or 115 of the order books shown in FIGS. 1 to 7A. However, in a further embodiment, the non-executable stop orders may be displayed with a symbol other than a dot. For example, a diamond may be used instead, as long as the chosen symbol distinguishes from the representation of an executable order. In any case, the visualization will include a symbol at the stop limit of the order to indicate that there is an order which will be triggered at the particular limit. Further, this particular graphical representation may be displayed only, if the current price level does not have a stop order volume greater than zero. However, in a different embodiment, the particular graphical representation, e.g. the dot 710 shown in FIG. 7B, may be displayed next to the graphical representation of the stop order volume class shown on the current price level.

As illustrated in FIG. 12A, the method then determines at step 1240 whether there is another price level in the order book, and, if so, the process proceeds to this next price level in step 1245. Otherwise, the method of FIG. 12A ends and the process returns to FIG. 8.

Turning now to FIG. 12B, an alternative process for generating and displaying the graphical representations is described. The process begins with finding a first stop order to be visualized (step 1250). In another embodiment, it is determined first whether any stop order exists that need to be visualized. However, in the depicted process, it is assumed that there is at least one stop order or that the process of FIG. 12B will only be started, if the overall process (such as the process of FIG. 8) is aware of a new stop order.

During the next step 1255 the order volume of the stop order is determined. This information may already be available from the process of FIG. 8 or may be evaluated from the stop order data. Moreover, in a further embodiment, the order volume may not be determined as an exact value, but rather as being in a particular range. This might simplify the visualization, since a plurality of stop orders may be displayed with an identical graphical representation. The user of the system may, for example, not be able to differentiate between the exact visualizations for an order having a volume of 990 and one with a volume of 1000 depending on the graphical resolution of the employed display screen. Further, the order volume may also be used as an indication to not visualize an order at all, such as orders having a marginal order volume. In this case, the process would end or search for a next stop order.

Referring back to FIG. 12B, it is further determined whether the stop order is executable within one price determination at step 1260. In particular, since a stop order needs to be triggered first, the execution of the order may not be possible immediately. As discussed with respect to FIGS. 3 and 7A, if the stop order is not executable within one price determination, a dot-symbol will be displayed (step 1262) as a graphical representation of the non-executable stop order. This symbol may be displayed in column 110 or 115 of the order books shown in FIGS. 1 to 7A. However, in a further embodiment, the non-executable stop orders may be displayed with a symbol other than a dot. For example, a diamond may be used instead, as long as the chosen symbol distinguishes from the representation of an executable order. In any case, the visualization will include a symbol at the stop limit of the order to indicate that there is an order which will be triggered at the particular limit.

In case of a stop order which may be executable within one price determination (step 1260), price levels corresponding to the order are evaluated for depiction at step 1265. As an example, these price levels may be all price levels currently depicted in the order book which are a limit value of the order or between the limit values. In case of a stop market order, these price levels are all price levels between and including the stop limit triggering the order and the market price level for buying/selling the tradable item.

Further, for each of the evaluated price levels, it is checked whether another stop order is already graphically represented on that particular level (step 1270). If all price levels corresponding to the stop order do not contain a graphical representation, the process of FIG. 12B displays a graphical representation (step 1272) covering all price levels determined for the stop order. The graphical representation may be, in an embodiment, a bar, so that a rectangle will be displayed which extends between the evaluated price levels.

This has been discussed in greater detail above with respect to, for example, FIG. 1, 2 or 7B.

If, however, the visualization already includes graphical representations, for each price level corresponding to the stop order, a graphical representation will be displayed at step 1275 which is adjacent to the already displayed representation. For example, if a bar is used for depiction, a bar will be placed next to the already displayed bar on each price level. Further, dependent on the type of order, i.e. buying or selling, the graphical representation will be displayed on the right-hand side or the left-hand side of existing graphical representations, respectively. For instance, as can be seen in FIG. 7A, the graphical representation for a first stop order on the buying side is left-aligned and the additional stop orders are represented by adjacent bars placed on the right side of the first graphical representation. Similarly, the graphical representation for a first stop order on the selling side is right-aligned and the additional stop orders are represented by adjacent bars placed on the left side of the first graphical representation.

As mentioned above, the current stop order may be for buying or selling of the tradable item. Since the order type is known from step 815 of FIG. 8, the displaying (step 1262 or 1272) can easily be performed on the corresponding side of the order book. In a different embodiment, a step of determining the order type is performed before the displaying steps 1262 and/or 1272.

If all stop orders have been processed (step 1280), the process ends and may return back to FIG. 8. If there is an unprocessed stop order left, the method of FIG. 12B searches for the next stop order at step 1285 and repeats the steps 1255 to 1280.

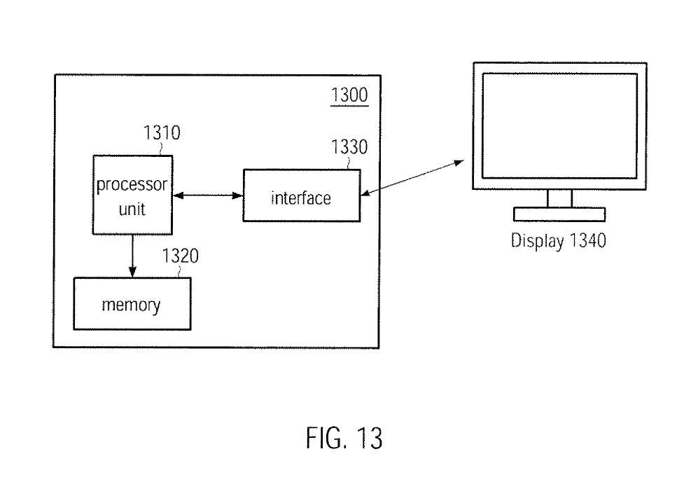

Having described the visualization of the order book and the process to generate the visualization, there will be provided a brief description of a system for implementing the present invention. With respect to FIG. 13, a system 1300 is illustrated which includes certain components. For instance, FIG. 13 shows a processor unit 1310, such as one or more CPUs. Further, a memory 1320 is depicted which is coupled to the processor unit 1310.

The system 1300 may further include an interface 1330, such as a video adaptor, to couple a display 1340 to the system 1300.

It is to be noted that the system 1300 may include, in another embodiment, further components or modules, such as a non-volatile memory implemented as a hard disk drive and a corresponding interface to couple the hard disk drive to the processor unit 1310. The system 1300 may further include a system bus which couples any component or module with the processor unit. In a further embodiment, the display 1340 may be implemented as a touch screen so that the display can also be employed as an inputting device.

While the invention has been described with respect to the physical embodiments constructed in accordance therewith, it will be apparent to those skilled in the art that various modifications, variations and improvements of the present invention may be made in light of the above teachings and within the purview of the appended claims without departing from the spirit and intended scope of the invention. In addition, those areas in which it is believed that those of ordinary skill in the art are familiar have not been described herein in order to not unnecessarily obscure the invention described herein. Accordingly, it is to be understood that the invention is not to be limited by the specific illustrative embodiments, but only by the scope of the appended claims.

What is claimed is:

1. A computer-implemented method of visualizing trading data using a graphical user interface of a computer system, the method comprising:
displaying a price range comprising graduated price levels for a tradable item;
receiving data of at least one stop order for the tradable item;
evaluating the data of the at least one stop order to determine price levels associated with each of the at least one stop order; and
displaying a graphical representation of the at least one stop order in the price range according to the evaluated price levels.

2. The method of claim 1, wherein the received data of the at least one stop order comprises at least one of a trade type indicating whether the stop order is for buying or selling the tradable item, a stop limit value, an order limit value, and an order quantity.

3. The method of claim 1, wherein the displayed price range comprises one row for each price level starting from a highest displayed price level and decreasing to a lowest displayed price level.

4. The method of claim 3, wherein the highest displayed price level corresponds to the market price for buying the tradable item and the lowest displayed price level corresponds to the market price for selling the tradable item.

5. The method of claim 2, further comprising:
determining whether each of the at least one stop order is executable based at least on one of the stop limit value and the order limit value.

6. The method of claim 5, wherein the graphical representation of the stop order is a dot at a price level corresponding to the stop limit value, if the stop order is not executable.

7. The method of claim 5, wherein displaying a graphical representation comprises for each displayed price level the steps of:
determining an accumulated executable order volume of stop orders;
determining a stop volume class into which the determined accumulated executable order volume falls; and
displaying a graphical representation corresponding to the determined stop volume class.

8. The method of claim 5, wherein the graphical representation of the stop order is a bar of a size covering the determined price levels and intermediate price levels, if the stop order is executable.

9. The method of claim 8, wherein a plurality of graphical representations for multiple stop orders are displayed adjacent to each other, wherein the plurality of bars are creating a solid polygonal area.

10. The method of claim 8, wherein one determined price level corresponds to the stop limit value and another determined price level corresponds to the market price for the tradable item.

11. The method of claim 8, wherein the stop order is a stop limit order, and wherein one determined price level corresponds to the stop limit value and another determined price level corresponds to the order limit value of the stop order.

12. The method of claim 2, further comprising:
calculating volume values representing certain order volumes executable on each price level.

13. The method of claim 12, wherein calculating volume values comprises:
determining whether the price range includes a price level equal to the stop limit value; and
if no corresponding price level is determined, creating a new price level in the price range.

14. The method of claim 13, wherein calculating volume values further comprises:
determining, based on the trade type of the stop order, whether the stop order is for buying or selling the tradable item;
determining whether the stop order is a stop limit order;
if the stop order is a stop limit order, calculating, for the determined trade type, a stop volume for each price level from the price level equal to the stop limit value to a price level equal to the order limit value of the stop order;
if the stop order is not a stop limit order, calculating, for the determined trade type, a stop volume for each price level from the price level equal to the stop limit value to a price level equal to the market price value of the price range for the determined trade type; and
wherein the method further comprises:
displaying the calculated stop volume for the determined trade type.

15. The method of claim 14, wherein calculating volume values further comprises:
calculating, for each price level in the price range and for each trade type, a summarized volume of limit and market orders; and
displaying the summarized volume of limit and market orders for each trade type.

16. The method of claim 15, wherein calculating volume values further comprises:
calculating, for each price level in the price range and for each trade type, a summarized order volume comprising the calculated stop volume and the calculated volume of limit and market orders; and
displaying the summarized order volume for each trade type.

17. The method of claim 16, wherein calculating volume values further comprises:
calculating, for each price level in the price range, a surplus volume of the difference of the summarized order volumes of the trade types; and
displaying the surplus volume for the trade type having the higher summarized order volume.

18. A trading data visualization system, comprising:
a processor;
a memory coupled to the processor; and
a display;
wherein the memory is adapted to store on one or more computer-readable media computer-executable instructions, that, when executed by the processor, perform a method of visualizing trading data on the display using a graphical user interface, the method comprising:
displaying in the graphical user interface a price range comprising graduated price levels for a tradable item;
receiving data of a first stop order for the tradable item;
evaluating the data of the first stop order to determine price levels associated with the first stop order; and
displaying in the graphical user interface a first graphical representation of the first stop order in the price range according to the evaluated price levels.

19. The system of claim 18, wherein the system is configured to receive evaluated data of a second stop order, and wherein the method further comprises for each displayed price level the steps of:
determining an accumulated executable order volume of the first and second stop orders;
determining a stop volume class into which the determined accumulated executable order volume falls; and
displaying a graphical representation of the first and second stop orders corresponding to the determined stop volume class.

20. The system of claim 18, wherein the system is configured to receive evaluated data of a second stop order, and wherein the method further comprises:
displaying a second graphical representation of the second stop order in the price range according to the received evaluated data adjacent to the displayed first graphical representation of the first stop order.

21. One or more computer-readable media storing computer-executable instructions, that, when executed by a processor, perform a method for calculating order volume values for trading data to be visualized at a graphical user interface, the method comprising:
receiving data of a stop order for a tradable item;
evaluating the data of the stop order to determine price levels associated with the stop order;
determining whether the determined price levels are part of a price range;
if the determined price levels are not part of the price range, creating a new price level in the price range; and
calculating, based on the evaluated data, order volume values representing certain order volumes executable on each price level of the price range.
